(19) United States
(12) Patent Application Publication
(10) Pub. No.: US 2015/0013273 A1
(43) Pub. Date: Jan. 15, 2015

(54) Expanded Content Heat Shrinkable Label

(71) Applicant: Sancoa International Company, L.P., Lumberton, NJ (US)

(72) Inventors: Barron G. McKillip, Mickleton, NJ (US); Barry Hostetter, Landenberg, PA (US); Ulrich E. Weyermann, Bethany Beach, DE (US)

(73) Assignee: Sancoa International Company, L.P., Lumberton, NJ (US)

(21) Appl. No.: 14/332,313

(22) Filed: Jul. 15, 2014

Related U.S. Application Data
(60) Provisional application No. 61/846,334, filed on Jul. 15, 2013.

(51) Int. Cl. G09F 3/00; G09F 3/04; B65B 53/02

(52) U.S. Cl. CPC G09F 3/0289; B65B 53/02; G09F 3/0295; G09F 3/04; G09F 2003/0208
USPC 53/442; 428/77

(57) ABSTRACT

The present invention is tamper evident shrinkable label with expanded content. The label comprises a label formed from a film having first and second ends, an adhesive coating on a backside of the label for attachment to a consumer product, an expanded content panel at least partly defined by the first end of the label and extending past the second end of the label on a consumer product, and a release coating on a front side of the label positioned opposite to releasably adhere to the backside of the expanded content panel on a consumer product.

### CROSS-REFERENCE TO RELATED APPLICATIONS

This application is a non-provisional application of, and claims the benefit of priority to, U.S. Provisional Application Serial No. 61/846,334 filed Jul. 15, 2013, the entire disclosure of which is expressly incorporated herein by reference.

### BACKGROUND

1. Field of the Disclosure The present disclosure relates to an expanded content heat shrinkable full body label and an expanded content heat shrinkable full body label with a tamper evident feature.

2. Related Art

Efficient and cost effective communication of information to a consumer is important for any business. Labels are commonly used on tubes, containers, and other items to advertise and communicate safety, proper use, and other information to consumers. Heat shrinkable films have been used in the past to label and decorate consumer products. In some cases it may be desirable to provide heat shrinkable labels with expanded content labeling. Likewise, in some cases it may be desirable to provide heat shrinkable labels with tamper evident features.

What would be desirable, but has not yet been developed, is a full body heat shrinkable label with an expanded content panel and/or a tamper evident feature.

### SUMMARY

The present disclosure relates to an expanded content heat shrinkable full body label and an expanded content heat shrinkable full body label with a tamper evident feature. Such a label could be cut to any desired geometry and applied to virtually any type of product or container. The label could be single ply or multi ply, and could be made of any machine direction heat shrinkable film (e.g., polyethylene). Methods of manufacturing a heat shrinkable label with an expanded content panel and/or a tamper evident feature are also disclosed.

### BRIEF DESCRIPTION OF THE DRAWINGS

The foregoing features of the disclosure will be apparent from the following Detailed Description, taken in connection with the accompanying drawings, in which:

FIG. 1 shows a full body heat shrinkable label with an expanded content panel;

FIG. 2 shows the label of FIG. 1 applied to a tube with the expanded content panel closed;

FIG. 3 shows the label of FIG. 1 applied to a tube with the expanded content panel open;

FIG. 4 shows a full body heat shrinkable label with expanded content panel and a tamper evident feature for use with a tube;

FIG. 5 shows the label of FIG. 4 applied to a tube with the expanded content panel closed;

FIG. 6 shows the label of FIG. 4 applied to a tube with the expanded content panel open;

FIG. 7 shows a full body heat shrinkable label with an expanded content panel and tamper evident feature for use with a container;

FIG. 8 shows a container to which the label of FIG. 7 could be applied;

FIG. 9 shows the label of FIG. 7 applied to a container with the expanded content panel closed;

FIG. 10 shows the label of FIG. 7 applied to a container with the expanded content panel open;

FIG. 11 shows a full body heat shrinkable label with an expanded content panel and another tamper evident feature;

FIG. 12 shows a full body heat shrinkable label with a removable expanded content panel and a tamper evident feature;

FIG. 13 shows the label of FIG. 12 applied to a container with the expanded content panel closed;

FIG. 14 shows the label of FIG. 12 applied to a container with the expanded content panel open and removed;

FIG. 15 shows processing steps for applying a label of the present disclosure to a container;

FIGS. 16A-B shows processing steps for applying a label of the present disclosure to a tube; and

FIG. 17 shows processing steps for applying a label of the present disclosure to a container.

### DETAILED DESCRIPTION

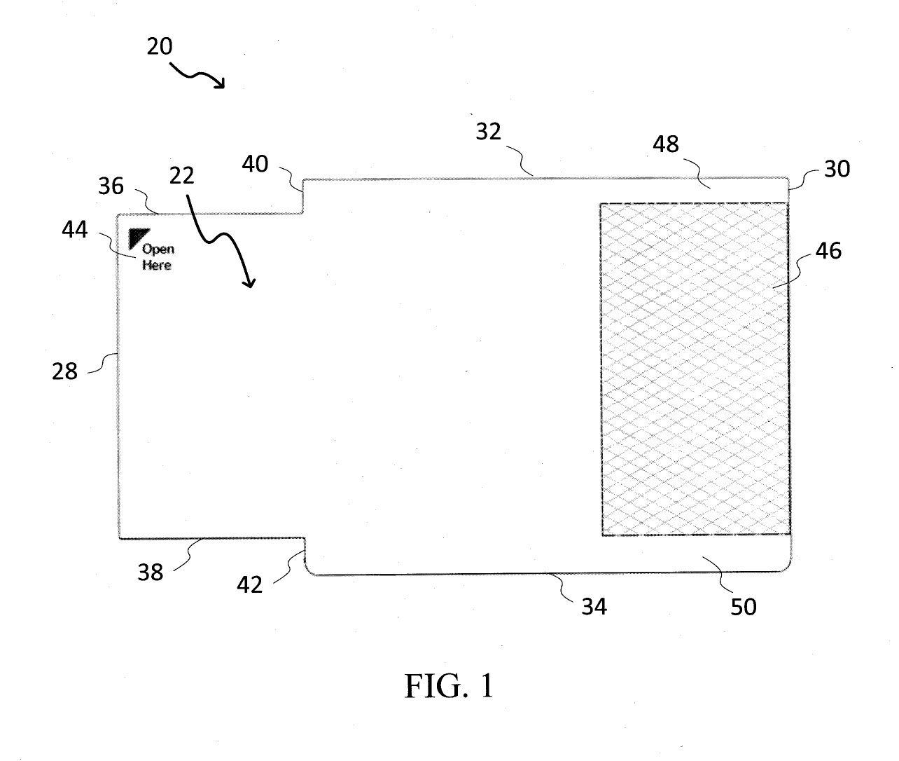

The present disclosure relates to a machine direction heat shrinkable label with expanded content panel and/or tamper evident feature, as discussed below in connection with FIGS. 1-17. More specifically, the present disclosure relates to a full body heat shrinkable label with an expanded content panel and/or a tamper evident mechanism applied to a tube or container. Expanded content labels can be formed with a label that wraps around a container or tube and back over onto a portion of the label as will be discussed.

The label of the present disclosure is a heat shrinkable full body label (although the label could cover less than the full body). The label could be formed (e.g., die cut) to a desired geometry based on the dimensions of a desired expanded content panel and/or tamper evident feature and the dimensions of a specified tube or container. The label can be produced from a polyethylene (PE) machine direction orientated (MDO) heat shrinkable film, although any type of material or MDO heat shrinkable film could be used The labels could be applied to any consumer product tube or container, particularly flexible (e.g., squeezable) tubes and pharmaceutical containers. The PE MDO shrink film is particularly suited for labels used on flexible plastic tubes because the film does not deform, crease, or craze as the tube is squeezed. The label could be applied to various types of flexible tubes including tubes with a crimp seal, which closes the tube with filled product, and a cap (e.g., snap-on or screw-on).

FIGS. 1-3 show a label 20 with an expanded content panel 22 for use with a tube or container. More specifically, FIG. 1 shows a front view of a label 20 with an expanded content panel 22. The label 20 includes a left edge 28, a right edge 30, a top edge 32, and a bottom edge 34. The expanded content panel 22 includes a top edge 36 and a bottom edge 38. The expanded content panel 22 can be shorter in height than the label 20; the top and bottom edges 32 and 34 of the label can extend past the top and bottom edges 36 and 38 of the expanded content panel. As a result, the top edges 32, 36 are connected by a vertical top edge 40, and the bottom edges 34, 38 are connected by a vertical bottom edge 42. The expanded content panel 22 could include indicia 44 to direct a user as to proper use of the expanded content panel 22. More specifically, the expanded content panel 22 could include indicia 44 to indicate that the panel 22 is peelable and/or the easiest place from which to peel the panel 22 open.

The label 20 can further include a release coating 46 positioned on the opposite side of label 20 from the expanded content panel 22. The release coating could be silicone-based (e.g., GE Silicone UV 9430), wax-based, Teflon, low tack coating, etc. The release coating 46 can extend to or near the top edge 32 or bottom edge 34, thus forming a top non-coated portion 48 and a bottom non-coated portion 50 between any space between the coating 46 and edges 32 and 34. The size of the coating 46 can correspond to the size of the expanded content panel 22.

The label 20 can be positioned on a container or tube to cover all or part of any contoured areas (e.g., curved or non-flat) of the container or tube. The label 20 could extend beyond the top end and/or bottom end of the container or tube. Subsequently, heat could be applied (e.g., by hot air or steam) to shrink the label 20 tightly to the contoured areas, top end, and/or bottom end of the tube or container. The expanded content panel 22 and/or tamper evident features could be in the area of label shrinkage. The MD heat shrinkable label 20 could be positioned on the container or tube so that the MD direction is in the circumferential direction of the tube or container.

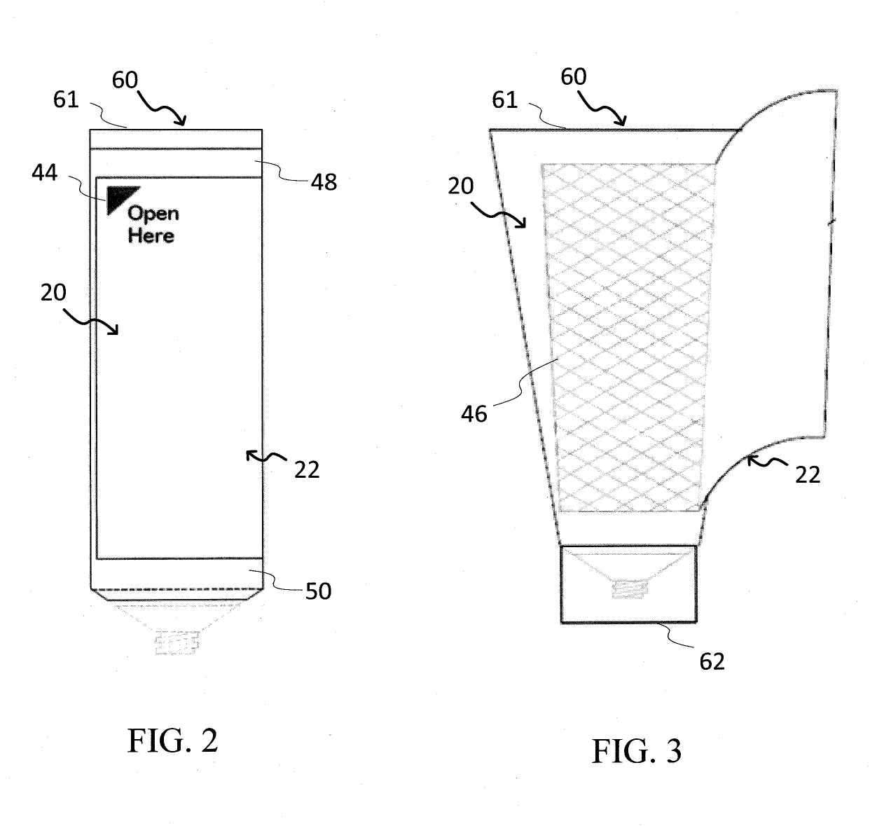

FIG. 2 shows the label 20 of FIG. 1 applied to a tube 60 with the expanded content panel 22 closed. The label 20 can be attached to the tube with a pressure sensitive adhesive. The label 20 wraps around the tube such that the top and bottom vertical edges 40, 42 extend past right edge 30 (e.g., 370° wrap), but the expanded content panel 22 extends over and substantially covers the release coating 46. As such, the label 20 could extend approximately 1.5 times around the container or tube (e.g., a 540° wrap) or more or less depending on the desired content and desired sizing Accordingly, the expanded content panel 22 could extend partially or completely around the circumference of the tube 60 to which it is applied. Further, the expanded content panel 22 could be positioned to be at the front or back of the tube 60. The label 20 applied to the tube 60 could extend to the top edge 61 of the tube 60. If the label 20 extends in the area of the top edge 61, the label 20 will be part of the crimp seal, resulting in a full body label. For example, see U.S. Patent Application Publication No. 2007/0084556 and U.S. Patent Application. Publication No. 2007/0084557, the entire disclosures of which are hereby incorporated herein by reference.

FIG. 3 shows the label 20 of FIG. 1 applied to a tube 60 having a cap 62, with the expanded content panel 22 open. As shown, the release coating 46 allows the label to be easily peeled back (e.g., lifted) to view the expanded content, and still be resealable. Opening the expanded content panel 22 reveals to a consumer additional content or information which could be printed on the inside of the expanded content panel 22 and/or the release coating 46.

The labels of the present disclosure could be multi ply (e.g., two or more films) or single ply (e.g., one film) labels. Materials for a two ply label include a top ply, a bottom ply, a laminating adhesive, a pressure sensitive adhesive (e.g., on the bottom ply), and a silicone release liner. The top ply could be a unidirectional oriented polyethylene based heat shrinkable film. The bottom ply could be a unidirectional oriented polyethylene based heat shrinkable film or a non-shrink thin polyethylene based film. The top ply could be reverse or surface printed or the bottom ply could be surface printed. A laminating adhesive could be used to attach the first ply to the second ply. Materials for a single ply label could include a unidirectional oriented polyethylene based heat shrinkable film, a pressure sensitive adhesive, and a silicone release liner. In either single ply or multi ply label constructions, the MD heat shrinkable films could include films made of polyethylene (PE), polypropylene (PP), PE copolymers, PP copolymers, PE/PP or PP/PE polymer blends, poly vinyl chloride (PVC), polyethylene terephthalate (PET), polyethylene terephthalate glycol copolymer (PETG), polystyrene (PS), or poly lactic acid (PLA). All MD heat shrinkable films should have preferential MD heat shrinkage and minimal transverse direction (TD) shrinkage. Upon heat activation, the films should exhibit MD direction shrinkage of at least 10% and up to 80%. The TD direction shrinkage should be less than 10% and preferably less than 5% in the same temperature range as the MD direction shrinkage. In either type, the label could be pre-coated or subsequently coated (e.g., pattern coat) with a pressure-sensitive adhesive to adhere the label to a surface of a container. If pre-coated, certain portions of the label could be overcoated with an adhesive deadener so that those portions will not adhere to a surface, such as the tamper evident panel, discussed in more detail below. If subsequently coated, the label could be pattern coated so that certain portions of the label will not be coated and will not adhere to a surface, such as the tamper evident panel, discussed in more detail below.

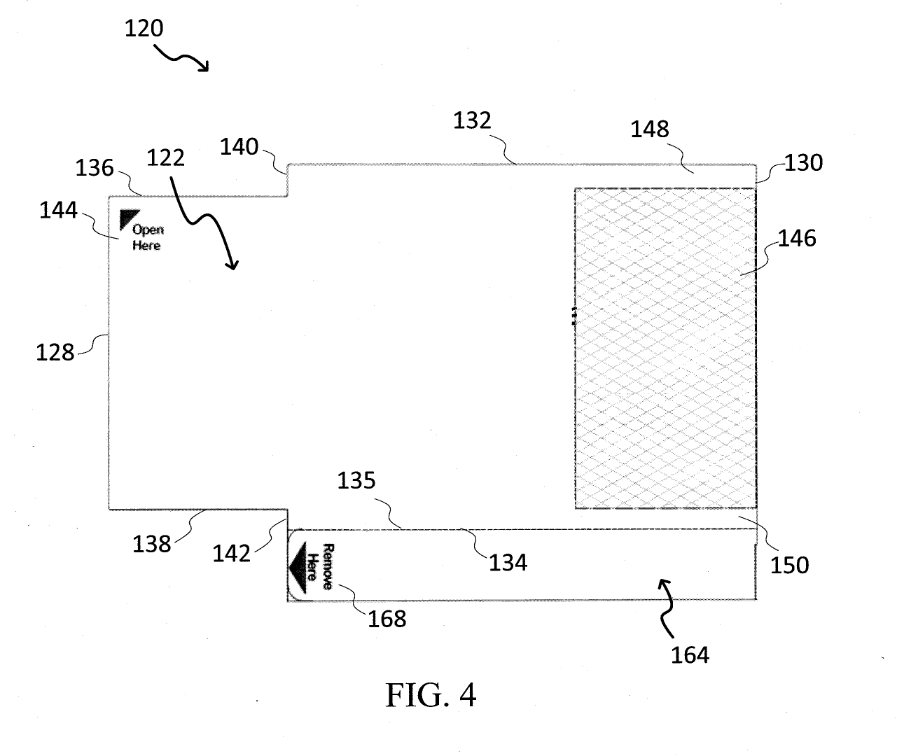

FIGS. 4-6 show a label 120 with an expanded content panel 122 and a tamper evident feature for use with a tube 160. More specifically, FIG. 4 shows a front view of label 120, which has, like the label shown in FIGS. 1-3, a left edge 128, a right edge 130, a top edge 132, and a bottom edge 134. The expanded content panel 122 includes indicia 144, as well as a top edge 136 and a bottom edge 138, the top edges 132, 136 connected by a vertical top edge 140, and the bottom edges 134, 138 connected by a vertical bottom edge 142. The label 120 includes a release coating 146 positioned on the opposite side of label 120 from the expanded content panel 122, as well as a top non-coated portion 148 and a bottom non-coated portion 150.

The tamper evident feature comprises a panel 164 that extends from, and is attached to, bottom edge 134, and is sized between the right edge 130 and bottom vertical edge 142 to extend fully around a cap on a container or a tube. The tamper evident panel 164 can be easily, but permanently, detached from the label 120 by a consumer prior to use to open the container or tube. The tamper evident panel 164 could be removed from the label 120 by separating it therefrom. A perforation line 135 or any other suitable means (e.g., a nicked or pre-cut line) to allow for the tamper evident panel 164 to be removed while leaving the label 120 intact (e.g., not damaged or deformed) on the tube. Adhesive can be pattern coated so that it is applied to the label 120, but not to panel 164. Alternatively, if adhesive is already applied to the label 120, the panel 164 can be overcoated with an adhesive deadener material (e.g., blocked) so that the panel 164 is no longer adhesive and is unattached to the cap upon application of the label to the container. The tamper evident panel 164 could also include indicia 168, similar to indicia 144, which could provide operating instructions and/or other information.

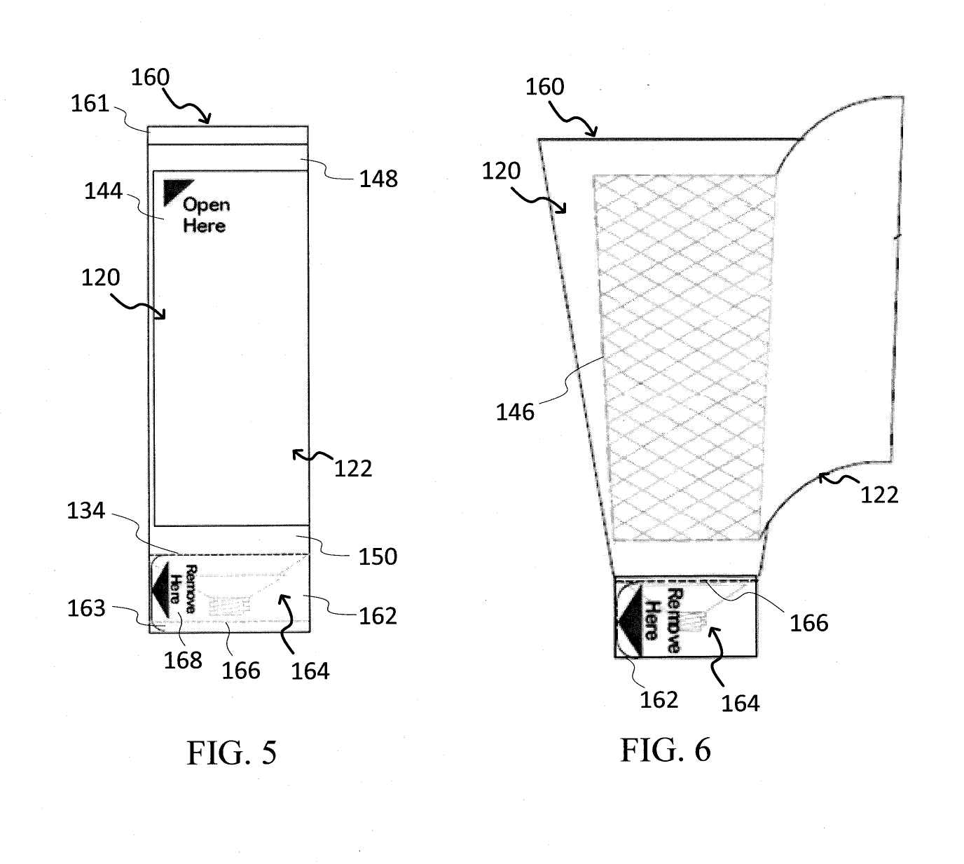

FIG. 5 shows the label 120 of FIG. 4 applied to a tube 160 with the expanded content panel 122 closed. As shown, the tamper evident panel 164 extends from the label 120 and surrounds (but is not attached to) the cap 162 of the tube 160. The tamper evident panel 164 of the label 120 extends past end 166 of the cap 162 of the tube 160. The perforated line 135 could be at any location between the cap 162 and the tube body 161. To remove the cap 162, a user could first remove the tamper evident panel 164 by detaching it from the label 120, such as by peeling along perforated line 135. Alternatively, the backside of tamper evident panel 164 could be adhered to the cap 162, such that by removing the cap 162 (e.g., by twisting), the tamper evident panel 164 detaches from the label 120 along perforated line 135. This would allow a user to know whether the cap 162 had been previously removed, but the user would not have to dispose of the tamper evident panel 164 separately from the tube 160.

FIG. 6 shows the label 120 of FIG. 4 applied to a tube 160 with the expanded content panel 122 open. As shown, the label 120 and tamper evident panel 164 are shrunk such the portion 163 of the panel 164 that extended beyond the cap now extends over and partially covers the top of the cap about its circumference. As shown, peeling back the expanded content panel 122 reveals additional information which could be printed on the inside of the expanded content panel 122 and/or the release coating 146.

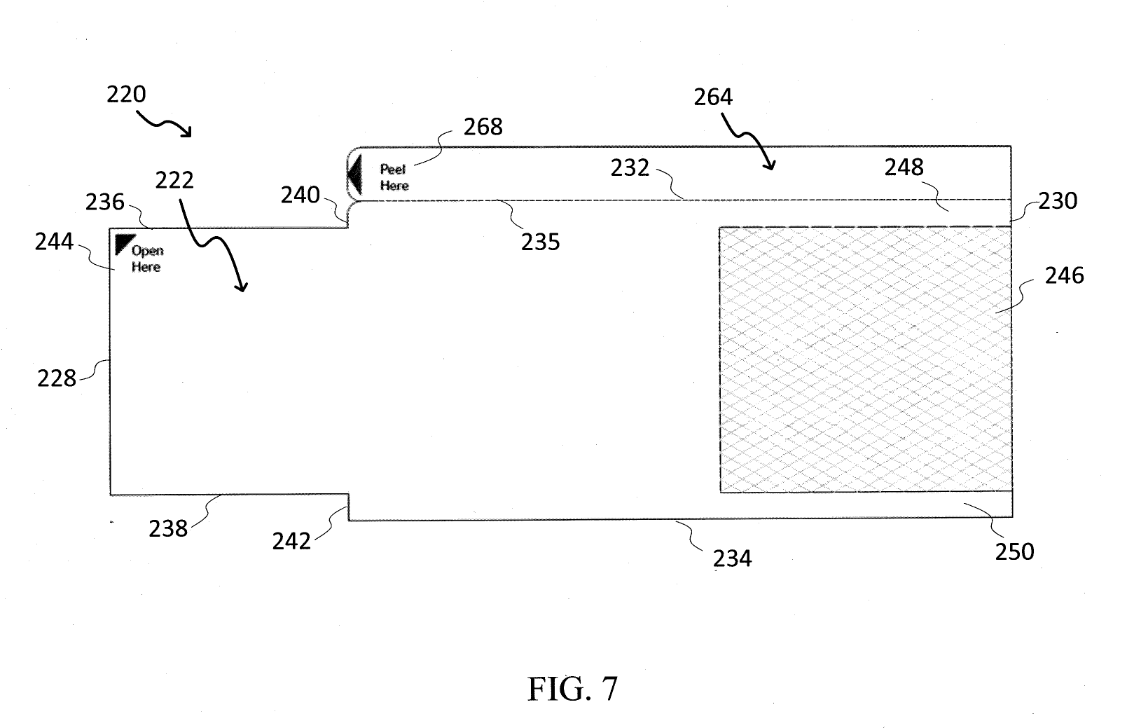

FIGS. 7-10 show a label 220 with an expanded content panel 222 and a tamper evident panel 264 for use with a container 260. More specifically, FIG. 7 shows a front view of label 220, which has, like the labels shown in FIGS. 1-6, a left edge 228, a right edge 230, a top edge 232, and a bottom edge 234. The expanded content panel 222 may include indicia 244, as well as a top edge 236 and a bottom edge 238, the top edges 232, 236 connected by a vertical top edge 240, and the bottom edges 234, 238 connected by a vertical bottom edge 242. The label 220 includes a release coating 246 positioned on the opposite side of label 220 from the expanded content panel 222, as well as top non-coated portion 248 and bottom non-coated portion 250.

In this embodiment, the tamper evident panel 264 includes indicia 268 and extends from, and is attached to, top edge 232 along perforated line 235, and is sized between the right edge 230 and top vertical edge 240. The tamper evident panel 264 works the same as with the label shown in FIGS. 4-6.

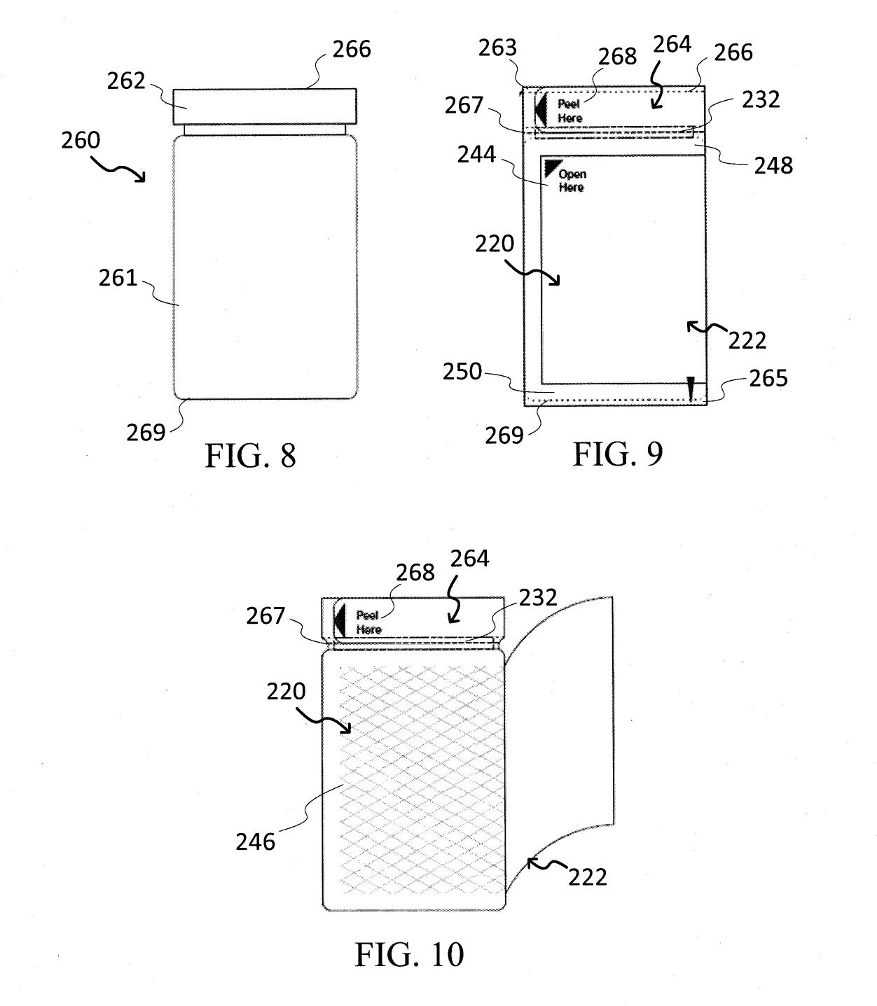

FIG. 8 shows a container 260 having a body 261 with a bottom end 269 and cap 262 with a top end 266. FIG. 9 shows the label 220 of FIG. 7 applied to the container 260 with the expanded content panel 222 closed and prior to shrinking the label 220. The label 220 and expanded content panel 222 are used the same way as in the labels shown in FIGS. 1-6. As shown, the label 220 and expanded content panel 222 are affixed to the container 260 and the label 220 and tamper evident panel 264 extend past the top 266 and bottom 269 of the container 260 at 263 and 265, respectively. Similar to the label shown in FIGS. 4-6, the tamper evident panel 264 surrounds the cap 262 of the container 260, and could optionally be adhered to the cap 262. To remove the cap 262, a user must first remove the tamper evident panel 264 by detaching it from the label 220, such as by peeling along perforated line 235.

FIG. 10 shows the label 220 of FIG. 7 applied to a container 260 after heat shrinking with the expanded content panel 222 open. As shown, the label 220 and tamper evident panel 264 are shrunk such that the label is secured to the container and the portion of the panel 264 that extended beyond the cap extends over and partially covers the top of the cap about its circumference. Consistent with the label shown in FIGS. 4-6, peeling back the expanded content panel 222 reveals additional information which could be printed on the inside of the expanded content panel 222 and/or the release coating 246.

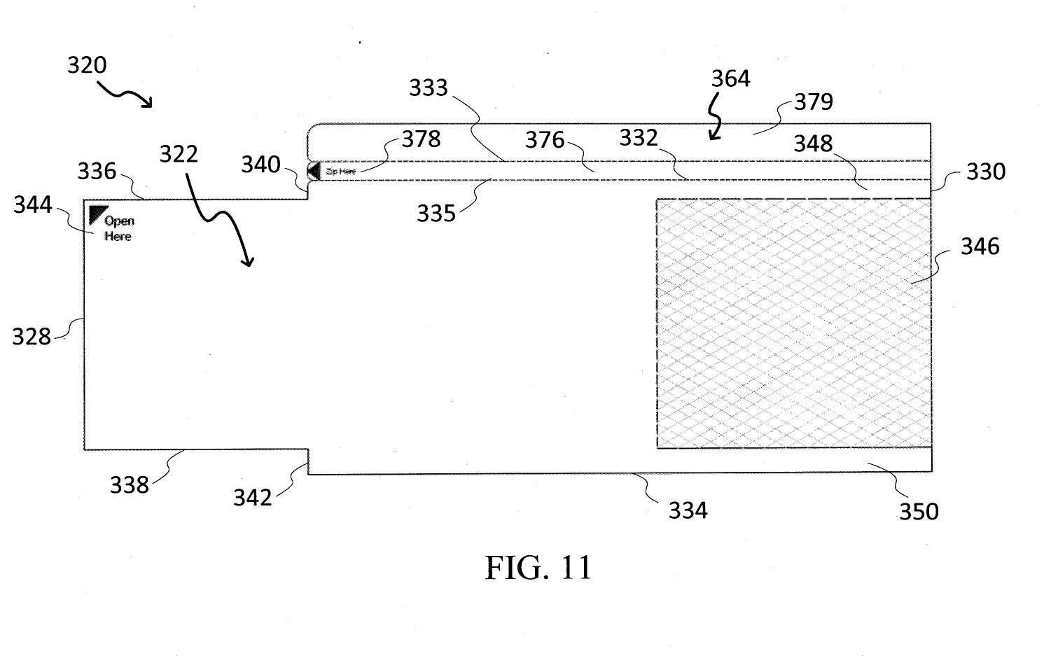

FIG. 11 shows a front view of label 320 with an expanded content panel 322 and tamper evident panel 364 for use with a container, which has, like the labels shown in FIGS. 1-10, a left edge 328, a right edge 330, a top edge 332, and a bottom edge 334. The expanded content panel 322 includes indicia 344, as well as a top edge 336 and a bottom edge 338, the top edges 332, 336 connected by a vertical top edge 340, and the bottom edges 334, 338 connected by a vertical bottom edge 342. The label 320 includes a release coating 346 positioned on the opposite side of label 320 from the expanded content panel 322, as well as top non-coated portion 348 and bottom non-coated portion 350.

The tamper evident panel 364 extends from, and is attached to, top edge 332 along perforated line 335, and is sized between the right edge 330 and top vertical edge 340. The tamper evident panel includes indicia 378, a lower portion 376, and an upper portion 379. The tamper evident panel 364 is attached to the top edge 332 of the label 320 by perforation or any other suitable attachment means. The upper portion 379 could be adhered to the cap of a container. When a user attempts to remove the lower portion 376, it detaches from the label 320 along top edge 332, and also detaches from the upper portion 379 along perforated line 333 (although any other suitable attachment to the upper portion 379 could be used).

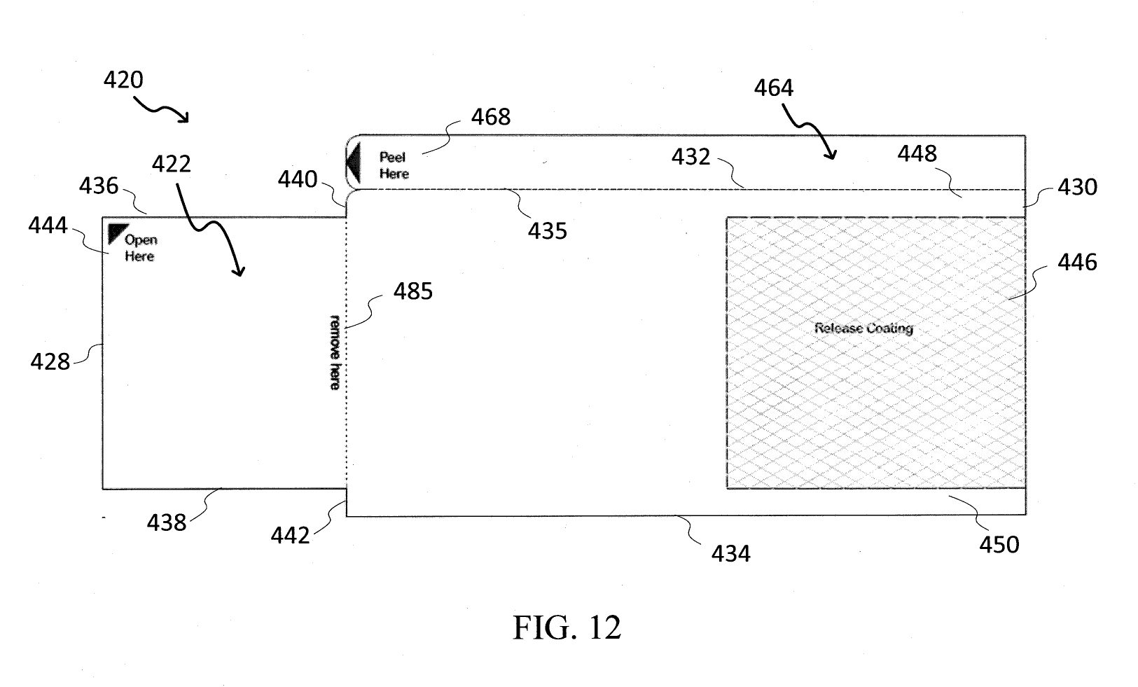

FIGS. 12-14 show a full body heat shrinkable label 420 with a removable expanded content panel 422 and a tamper evident panel 464 for use with a container 260. More specifically, FIG. 12 shows a front view of label 420, which has, like the labels shown in FIGS. 1-11, a left edge 428, a right edge 430, a top edge 432, and a bottom edge 434. The expanded content panel 422 may include indicia 444, as well as a top edge 436 and a bottom edge 438, the top edges 432, 436 connected by a vertical top edge 440, and the bottom edges 434, 438 connected by a vertical bottom edge 442. The label 420 includes a release coating 446 positioned on the opposite side of label 20 from the expanded content panel 422, as well as top non-coated portion 448 and bottom non-coated portion 450. Consistent with the description of the label of FIGS. 7-10, the tamper evident panel 464 includes indicia 468 and extends from, and is attached to, top edge 432 along perforated line 435, and is sized between the right edge 430 and top vertical edge 440. The expanded content panel 422 is attached to the rest of the label 420 by perforated line 485 (although any other suitable attachment to the upper portion 479 could be used), such that the expanded content panel 422 is completely detachable from the rest of the label 420.

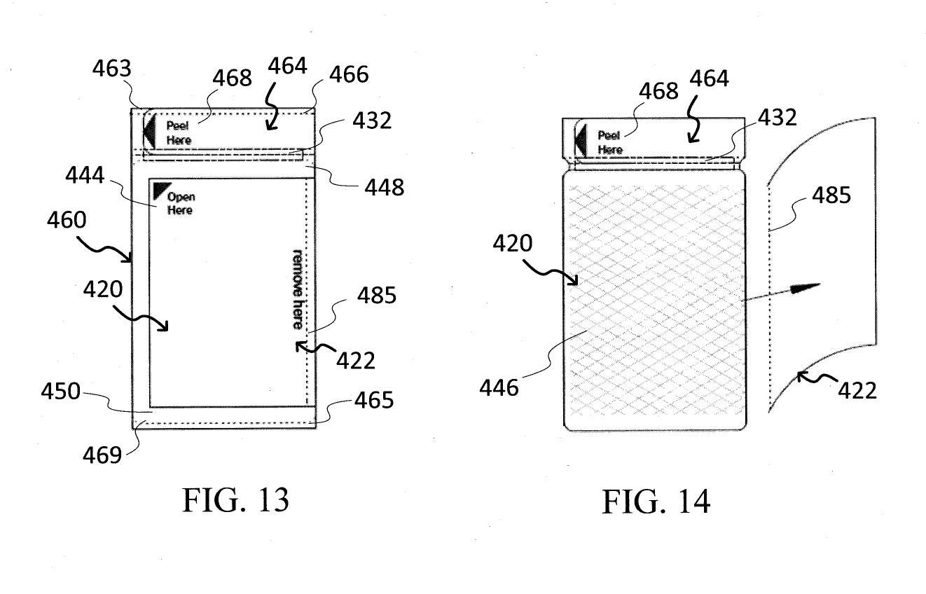

FIG. 13 shows the label 420 of FIG. 12 applied to the container 460 with the expanded content panel 422 closed and prior to shrinking the label 420. Like the label shown in FIG. 9, the label 420 and expanded content panel 422 are affixed to the container 460 and the label 420 and tamper evident panel 464 extend past the top 466 and bottom 469 of the container 460 at 463 and 465, respectively.

FIG. 14 shows the label 420 of FIG. 12 applied to a container 460 after heat shrinking with the removable expanded content panel 422 open. As shown, and consistent with the label of FIGS. 7-10, the label 420 and tamper evident panel 464 are shrunk such that the label is secured to the container 460 and the portion of the panel 464 extending beyond the cap extends over and partially covers the top of the cap about its circumference. Peeling back the expanded content panel 422 reveals additional information which could be printed on the inside of the expanded content panel 422 and/or the release coating 446. In addition, the expanded content panel 422 may be partially or completely removed from the label 420. The expanded content panel 422, is detachable from the label 420 along edge 485.

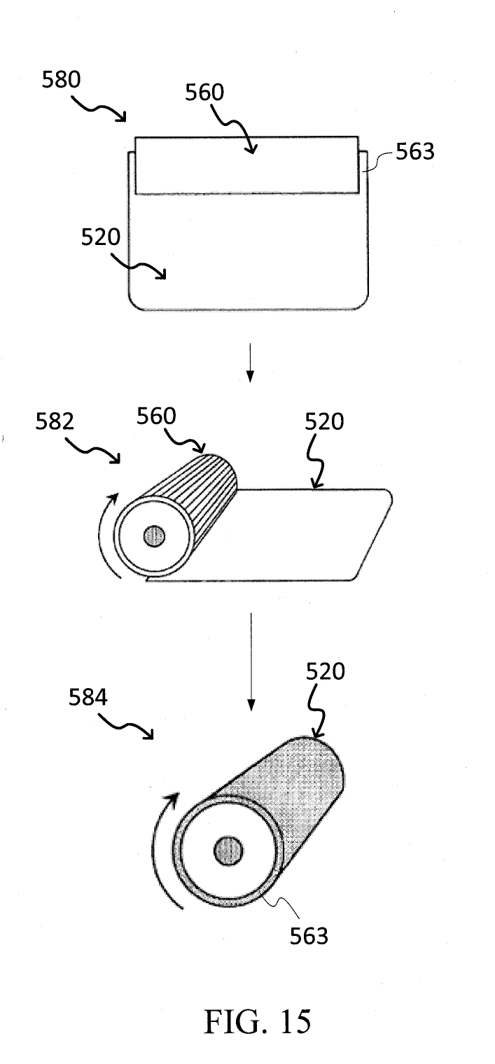

FIGS. 15-17 show processing steps for applying a label of the present disclosure to a tube or container. More specifically, FIG. 15 shows processing steps for applying a label 520 to a container 560. As shown, in step 580, the label 520 is positioned with respect to the container 560, preferably, such that the label 520 projects beyond the ends (e.g., top and bottom) of the container 560 to cover all or part of the container and lid. In step 582, the container 560 is rotated such that the label 520 adheres to the circumference of the container 560. In step 584, the label is heat shrunk such that the areas 563 that extend beyond the ends of the container 560 shrink to adhere tightly about the body of the container and the top and bottom of the container 560 such that the label 520 covers the full body of the container 560.

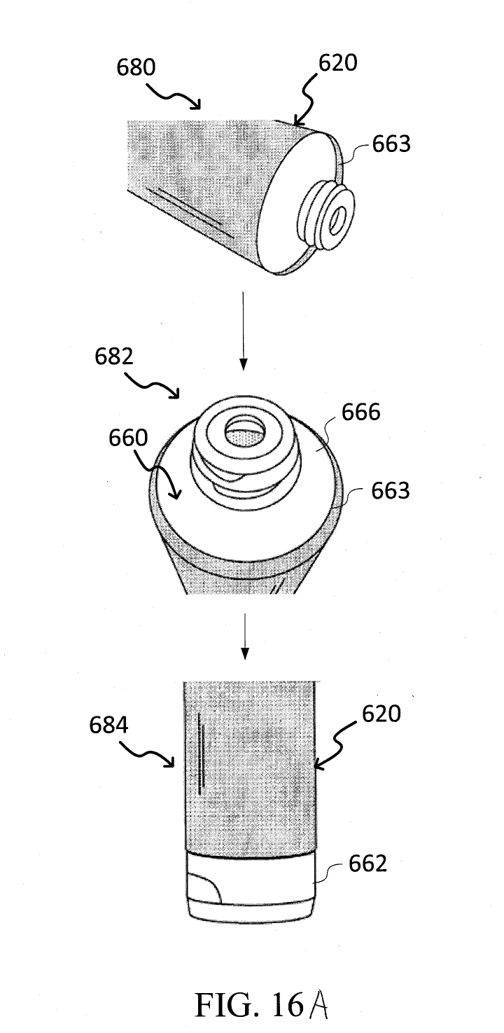

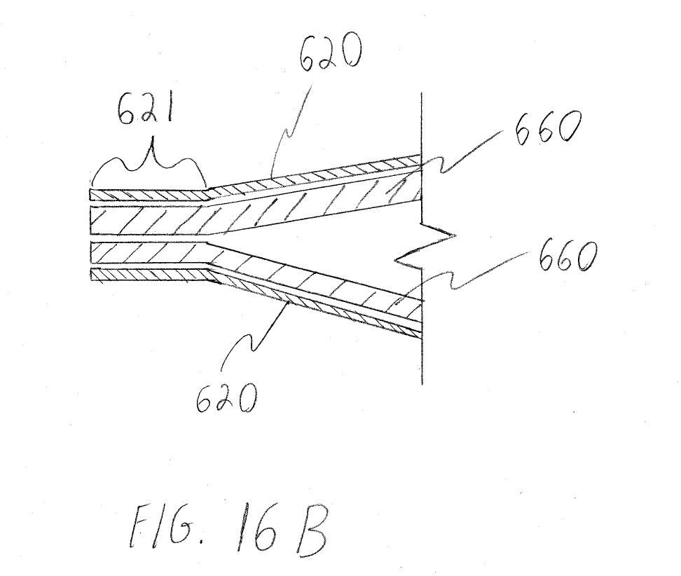

FIGS. 16A-B shows processing steps for applying a label 620 to a squeeze tube 660. In step 680, the label 620 is applied to the tube body so that the label 620 extends beyond an end surface 666 of the tube 660. In step 682, the label 620 is heat shrunk at an upper end of the shoulder of the tube 660 such that the area 663 that extends beyond the end of the tube shrinks to extend partially over the end surface 666 of the shoulder of the tube 660. Subsequently, in step 684, a cap 662 is then attached to the tube 660. At the bottom of the tube 660, the label can be positioned over the end of the tube and crimped with the tube 660 such that the lower end of the label 620, but not the expanded content panel, is included in the crimp 621. As shown in FIG. 16B, the crimp area 621 includes the label 620 and the tube 660 forming a label, tube, tube, label layered construction.

A tube is formed by extrusion or blow molding. For extrusion, a tubular cylinder is formed and a shoulder with an application orifice that contains a snap or thread closure feature is added to one open end of the tube. For a blow molded tube, the shoulder and application orifice are included. For shrink labeling over the shoulder of the tube, the label is applied and shrunk and the cap (e.g., snap or screw) is attached (which often sits on top of the shoulder and label). For shrink labeling with a tamper evident feature over the cap, the cap must be applied before labeling as the label including tamper evident area covers the cap. For all tubes, the tubes are formed and labeled with subsequent filling with product at the open end of the tube (opposite from the shoulder/cap). Once the tube is filed with product, the final step is to close the tube by a heat and pressure seal crimping. For all other containers (non-tubes), they do not have an open end opposite the lid or cap. In this case, the container can be labeled before or after filling with product if only using a shrink label. If a tamper evident feature is used, the product must be filled and capped before the label is applied. Containers do not require a crimp seal.

The heat shrinking of the label over the shoulder of the pre-formed tube can take place immediately after the label is applied to the tube body and before the cap is applied. The crimping of a tube can take place during an entirely different process at a filler (e.g., performed several weeks after decoration). After the product is filled in the decorated preformed tube through the open end, a heat gun is inserted which melts an inside layer in the seaming area. Immediately after that, mechanical jaws close on the tube, creating the crimped end. This is done in the last step of the manufacturing process of a filled and decorated tube.

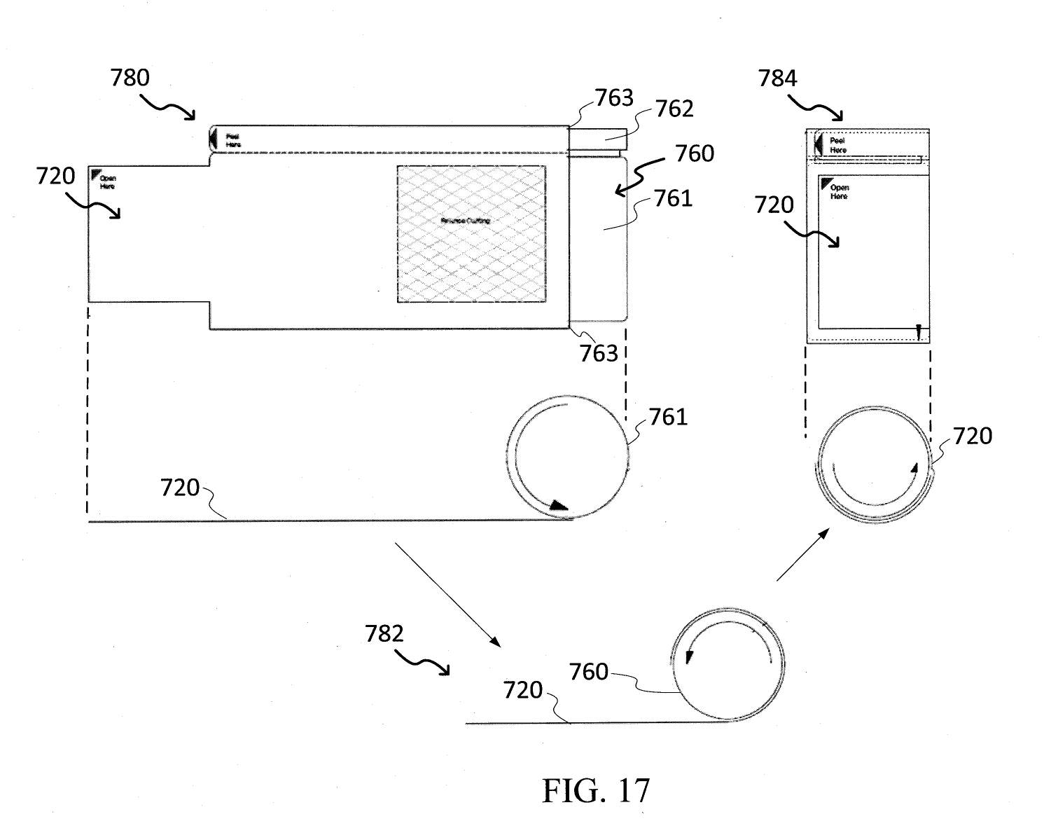

FIG. 17 shows processing steps for applying a label 720 to a container 760. As shown, in step 780, the label 720 is positioned with respect to the container 760, preferably, such that the label 720 extends beyond the ends (e.g., flat surfaces) of the container 760 (e.g., beyond the container body 761 and lid 762). In step 782, the container 760 is rotated such that the label 720 adheres to the circumference of the container 760. In step 784, the label is heat shrunk such that the areas 763 that extend beyond the ends of the container 760 shrink to adhere tightly to the body of the container 760 and the label 720 covers the full body of the container 760, and partially covers the lid and bottom.

The label of the present disclosure could be produced from a unidirectional-oriented polyethylene-based heat shrinkable polymeric film. The label could be produced in accordance with the teachings of International Publication Number WO 2012/116149 A2, the entire disclosure of which is expressly incorporated herein by reference. The label can be combined with a pressure-sensitive adhesive and used to label various consumer products. The instant label has a number of advantages. In particular, the instant label is produced with a biaxial-oriented and subsequently uniaxial machine direction-oriented polyethylene heat shrink film thereby providing the ability to use thinner films and produce labels with balanced tensile properties.

The unidirectional-oriented heat shrinkable label of the present disclosure could be composed of a primary polymeric component, which is a polyethylene. In certain embodiments, the polyethylene is composed of at least one polyethylene homopolymer, copolymers of polyethylene, blends of homopolymers or copolymers thereof that may be used in isolation as the primary polymeric component or combined with other polymeric materials or additive components to form the primary polymeric component. Exemplary polyethylene polymers of use in the instant label include High Density Polyethylene (HDPE; density greater than 0.941 g/cm³; melting temperature 126-135° C.), Medium Density Polyethylene (MDPE; density between 0.926 and 0.940 g/cm³; melting temperature 120-125° C.), Low Density Polyethylene (LDPE; density between 0.910 and 0.925 g/cm³; melting temperature 105-118° C.), Linear-Low Density Polyethylene (LLDPE; density between 0.919 and 0.925 g/cm³; melting temperature 126° C.), Ultra Low Density Polyethylene (ULDPE) or Very Low Density Polyethylene (VLDPE; density between 0.885 and 0.915 g/cm³), High Molecular Weight HDPE (HMW-HDPE; density in the range of 0.935 and 0.955 g/cm³), and analogues with bimodal and multimodal molecular weight distribution or blends of homopolymers or copolymers thereof. In certain embodiments, blends of polyethylene homopolymers or copolymers contain>50% ethylene. In one embodiment, the polyethylene of the instant label contains at least one polyethylene. In another embodiment, the polyethylene of the instant label consists of a polyethylene, or a blend of polyethylene homopolymers or polyethylene copolymers. The primary polymeric component or polyethylene is preferably from about 50 wt. % to about 100 wt. % of the unidirectional-oriented heat shrinkable polymeric film used in the production of the instant label.

In some embodiments, blends of HMW-HDPE and LLDPE are provided wherein the blend ratio is between 80/20 to 20/80, and melting index (190° C.) between 0.01 and 0.05 dg/minute.

In other embodiments, the instant label is produced with a HMW-HDPE with a density between 0.935 and 0.948 g/cm³ and melting index (190° C., ASTM 1238) between 0.03 and 0.15 dg/minute.

Blends of HDPE, MDPE, LLDPE, VLDPE including bimodal and multimodal molecular weight distribution could also be used. In some embodiments, the instant label contains greater than 50 wt. % HDPE or MDPE. In other embodiments, the instant label contains bimodal or multimodal HDPE. In yet other embodiments, the instant label contains 0% LDPE.

In addition to the polyethylene component, the labels of the present disclosure could also include an additive to improve or alter processing properties, shrinkage properties, tensile properties and optical properties. Certain additives can also be used to enhance the ability to unidirectional orient the film and result in acceptable shrinkage properties. Examples of additives include antioxidants, stabilizers, colorants, dispersing aids, and the like. Additives may also be utilized to impart additional functional properties such as coefficient of friction (COF) control, anti-block, or opacity. To aid in the machine direction uniaxial orientation process, particular embodiments feature the use of low molecular weight polyethylene (e.g., density 0.950 g/cm³, molecular weight 2654-5994 g/mol), olefin waxes, or very low density LLDPE as additives to the instant label. In certain embodiments, the additive is less than 50 wt. % of film composition. In other embodiments, the additive is about 1 wt. % to about 40 wt. % of the film used in the production of the instant label. While some embodiments feature the inclusion of an additive into the film used in the production of the instant label, other embodiments feature the use of an additive in a coating or vanish.

The polyethylene-based heat shrinkable label of the present disclosure can be composed of a single component or monolayer film. In other embodiments, the polyethylene-based heat shrinkable label is composed of a multilayered film containing two or more distinct layers of similar or of different compositions.

Multilayered labels of the present disclosure can include a varnish layer to provide a protective or functional coating; a transparent film outer layer; a reverse-printed transparent film outer layer; a surface-printed transparent film, opaque or metalized inside film layer; a non-shrink film layer; a pressure-sensitive adhesive layer; or a release film liner. Suitable outer layer films for the instant multilayered labels can be composed of machine direction heat shrink polyethylene-based films or non-shrink polyethylene or polypropylene-based films. Non-shrink films can be composed of a polyethylene or polypropylene. The non-shrink polyethylene or polypropylene film may be composed of homopolymers, copolymers, or blends of polyethylene or polypropylene homopolymers and copolymers. When the instant label is multilayered, preferably the label is a laminate, wherein one or more of the films of the laminate are unidirectional heat shrinkable films, and wherein the laminate includes a transparent outer film layer. In some embodiments, the label is a laminate composed of at least two layers, wherein at least one of the laminate film layers is a polyethylene-based unidirectional heat shrinkable film. In particular embodiments, the label of the present disclosure is a laminate composed of two film layers wherein both film layers are polyethylene-based unidirectional heat shrinkable films. In further embodiments, the label of the present disclosure is a laminate, wherein at least one of the films of the laminate is characterized as a polyethylene-based unidirectional heat shrinkable film and the laminate film includes a non-shrink film layer which is biaxial oriented polyethylene-based or biaxial oriented polypropylene -based. Wherein the label of the present disclosure is a lamination of more than one film, desirably the films of the laminate are combined by use of a permanent adhesive.

Labels of the present disclosure can be produced with a polyethylene unidirectional heat shrinkable film, and optionally a non-shrink film, with film thicknesses of between 10 microns to 200 microns. Wherein the label of the present disclosure is a produced from a laminate of a shrink and non-shrink film, the thickness of the shrink film is preferably greater than 50% of the total label thickness. Desirably the overall thickness of the instant label is between 0.5 mil to 10 mil.

The film of the instant label is produced by obtaining resins of the polyethylene of interest, extruding the polyethylene layer, biaxially orienting the extruded polyethylene layer, and subsequently uniaxial machine direction orienting the biaxially-oriented polyethylene layer, to form a machine direction unidirectional-oriented polyethylene-based heat shrinkable polymeric film. In certain embodiments, the machine direction orientation ratio is greater than 4/1. In other embodiments, the machine direction orientation ratio is less than 13/1. In particular embodiments, the machine direction orientation ratio is between 5/1 to 10/1. The machine direction film shrinkage is a result of the machine direction orientation ratio, where the annealing and stress relaxation is minimized and is at or below 100° C., preferably below 80-90° C. Advantageously, a label produced by the instant method has exceptional shrinkage, tensile properties and stiffness.

A label of the disclosure could be composed of a single film layer or multiple film layers. Multilayer films can be produced by coextrusion, extrusion coating, or coating. Wherein the instant label is composed of more than one layer, the label can have between one and five layers although any number of layers is possible, including even numbers of film component layers. Moreover, the surface of the label may be treated with corona or flame or coated to increase surface functionality and surface tension.

The label of this present disclosure has superior optical properties and, when composed of a transparent film, has a haze value of less than 10, or more particularly less than 6. Furthermore, the label of the present disclosure exhibits enhanced storage stability characteristics with shrink levels of less than 5% in the machine direction at or below 60° C., preferably at or below 70° C. or most preferably at or below 80° C. In some embodiments, the label exhibits less than 5% shrinkage in the machine direction at these temperatures.

Given its use in labeling articles of consumer products, the instant label can be produced in roll form and printed with product information, e.g., with graphics, images, text, coloration or other indicia over part or all of the surface of one or more of the films utilized in the label, and cut to the final label dimensions prior to application on the consumer product. In addition to product information, the instant label may be transparent, white, opaque, metalized or contain special enhancements such as embossing. Graphics, coloration, images, or text can be reverse-printed or surface-printed. In some embodiments, when the label is multilayered, the graphics, coloration, images, or text are reverse-printed on a transparent outer layer or surface printed on a transparent, opaque or metalized inside layer.

According to certain embodiments, the present disclosure features a label produced from a single ply polyethylene unidirectional heat shrinkable film, wherein the film is reverse-printed or surface-printed with an optional protective coating or varnish covering the print.

In other embodiments, the present disclosure features a label produced from a polyethylene unidirectional heat shrinkable film as a laminate, wherein where one or more of the films of the laminate are unidirectional heat shrinkable films, and wherein the laminate includes a transparent film as the outer layer.

In yet other embodiments, the present disclosure is a label produced from a polyethylene unidirectional heat shrinkable film, wherein the label is either a single ply film or a lamination of two films, and wherein the backside (inside) of the film is coated (100% coverage) with a pressure-sensitive adhesive. In certain embodiments, the adhesive has a high temperature shear strength of up to 160° F. In accordance with this embodiment, the label can further include a film-based release liner.

When applied to a consumer product, the backside (inside) of the label can be coated (100% coverage) with a pressure-sensitive adhesive. The pressure-sensitive adhesive can be applied after the label is printed with graphics or other indicia. The pressure-sensitive adhesive-coated label can then be laminated to a silicone-coated or similar release film (liner) or release substrate and subsequently die cut to the desired label dimension. Alternatively, in the case of a lamination structure, the pressure-sensitive adhesive and release liner can be laminated to a base film, which subsequently can be surface printed or alternately laminated to a reverse-printed transparent outside film, and die cut to the desired label dimension.

Pressure-sensitive adhesives of use in the instant disclosure include, but are not limited to, rubbery adhesive agents, vinyl acetate adhesive agents, ethylene-vinyl acetate adhesive agents, polyvinyl alcohol adhesive agents, polyvinyl acetal adhesive agents, vinyl chloride adhesive agents, acrylic adhesive agents, polyamide adhesive agents, polyethylene adhesive agents, cellulose adhesive agents, polysulfide adhesive agents and hot-melt type high-polymer-containing adhesives. Desirably, a pressure-sensitive adhesive of the present disclosure is pressure-sensitive in nature and is also characterized as being permanent once the label is applied, as having an adhesive shear strength of greater than 400 g/in, and is stable up to 70° C. In other embodiments, the adhesive has a high temperature shear strength of up to 160° F. (71° C.). A resultant pressure-sensitive adhesive applied label maintains good overlap seam integrity and no dog ears or label lift on the ends.

The label of the present disclosure is useful to label a variety of products. The label of the present disclosure exhibits a high degree of shrinkage in a very controlled and consistent manner while providing a number of other positive characteristics such as optical clarity, superior handling characteristics, exceptional tensile properties, stiffness, and storage stability. Moreover, to decrease the environmental impact of the instant label, desirably, the label of the present disclosure may contain greater than 10% or greater than 20% polyethylene recycle content. In particular embodiments, the recycle content of the instant label is in the range of 10 to 90%.

As indicated, the label is of use in labeling, covering, and/or decorating a variety of consumer product containers. The label may be used in a variety of labeling processes including roll fed, sleeve, cut and stack, and pressure-sensitive labeling.

A consumer product wrapped in a label of the present disclosure is also provided.

Consumer products include containers or tubes (e.g., flexible plastic tubes).

Labels can be produced, slit into a roll with a single lane of labels and applied with the appropriate labeling equipment to a consumer product container, wherein the circumference of the container is fully wrapped and is subsequently shrunk tightly to the container with the application of hot air or steam heat. The instant shrink label is particularly useful for application to non-uniform or contoured containers where the label as applied is tightly wrapped to the largest diameter of the container and is then, with the application of hot air or steam, shrunk tightly to the smaller diameter and contour areas of the container. The label may also be applied to extend over the top and/or bottom ends of the container and shrunk tightly around the radius and top and/or bottom of the container.

In some embodiments, such as use of a pressure-sensitive label, the label has a release liner, which is removed prior to application to the container or tube.

The shrink label of the disclosure is useful in tightly covering non-uniform contours of a container or tube and also may extend beyond the height of the body of the container and upon heat shrinkage forming a tight wrap and label to the surface of the container and top and/or bottom surfaces. The shrink label of the disclosure may contain an expanded content panel of the label that extends beyond the full wrap (e.g., 360 degrees) of the primary label and is preferably not located in the contoured or shrink areas of the label on the container.

In some embodiments the label could be formed (e.g., die cut) to a desired geometry based on the dimensions of a desired expanded content panel (and/or tamper evident feature) and the dimensions of a specified tube or container. The label wraps around the tube such that the expanded content panel extends over and substantially covers the primary (e.g., 360 degrees) label. As such, the label could extend approximately 1.5 times around the container or tube (e.g., a 540° wrap) or more or less depending on the desired content and desired sizing.

In some embodiments the shrink label of the disclosure may contain an expanded content panel and/or a tamper evident feature comprising a panel to extend fully around a cap on a container or a tube. The tamper evident panel can be easily, but permanently, detached from the label by a consumer prior to use to open the container or tube. The tamper evident panel could be removed from the label by separating it therefrom. A perforation line or any other suitable means (e.g., a nicked or pre-cut line) could be used to allow for the tamper evident panel to be removed while leaving the label intact (e.g., not damaged or deformed) on the tube.

In some embodiments the expanded content panel may be partially or completely removed from the label. The expanded content panel can be attached to the label by perforation or any other suitable attachment means. The expanded content panel can be detached from the label along a perforated edge, or other attachment that permits separation, such as a nicked or pre-cut line, to allow for the tamper evident panel to be removed while leaving the label intact (e.g., not damaged or deformed) on the tube or container.

When using the instant label to fully wrap a plastic tube, 100% of the exposed tube area can be decorated thereby eliminating issues with non-decorated stripes conventionally present on labeled extruded tubes. To achieve this, a heat shrinkable pressure-sensitive label is cut to a length that is longer than the tube and applied to the tube so that the label extends beyond the edge of the tube where the body and the shoulder of the head meet, and so that the label also extends into the heat seal crimp area of the tube. In a second step, the label is exposed to heat thereby causing the label to shrink over the shoulder and completely cover the tube body. The tube is completely covered by the label eliminating any undecorated stripe between the tube and cap.

One example of the present disclosure relates to methods for labeling a fully extruded tube with a snap cap. The following describes methods for labeling a fully extruded tube with a snap cap. In a first method, an extruded body tube sleeve is produced using mono or multilayer coextrusion process and the sleeve is cut to the desired length. The head is affixed to the tube body by compression molding or other means. Subsequently, the surface energy of tube body and conical head of tube is increased (e.g., by corona or flame treatment) to accept label adhesive most effectively. Subsequently, the cap is applied. A 540 degree die cut pressure sensitive label with a release liner containing an expanded content panel and a tamper evident panel with a full 360 degree perforation located between the top of the tube and the cap is applied to the tube. Heated air or radiant heat is then applied to the portion of the label at the conical head and cap to induce label shrinkage. As an optional step, the tube and/or closure is rotated to a position suitable to orient a closure to the front panel graphics on the label of the tube. The fully labeled tube is subsequently filled with product and heat seal crimped at the open end to produce a fully labeled flexible tube product.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A heat shrinkable label with expanded content for a consumer product, comprising:
a label formed from a film having first and second ends;
an adhesive coating on a backside of the label for attachment to a consumer product;
an expanded content panel at least partly defined by the first end of the label and extending past the second end of the label on a consumer product; and
a release coating on a front side of the label positioned opposite to releasably adhere to the backside of the expanded content panel on the consumer product.

2. The label of claim 1, wherein the expanded content panel is removable from the release coating on the label and reattachable thereto.

3. The label of claim 1, wherein the expanded content panel includes indicia.

4. The label of claim 3, wherein the indicia includes instructions.

5. The label of claim 1, wherein opening the expanded content panel reveals content on the label.

6. The label of claim 5, wherein the content is printed on the inside of the expanded content panel

7. The label of claim 5, wherein the content is printed on the label.

8. The label of claim 1, wherein the expanded content panel is permanently detachable from the label.

9. The label of claim 1, further comprising a tamper evident feature including a panel that extends from, and is removably attached to, an edge of the label.

10. The label of claim 1, wherein the consumer product is a container or a tube.

11. A method for labeling a tube, the tube having a body and a head attached to the body by a shoulder, comprising:
cutting a heat shrinkable label to a length that is longer than a tube;
applying the label to the tube so that the label extends above the shoulder; and
heat shrinking the label over the shoulder and around the tube body.

12. The method of claim 11, wherein the label is formed from a film having first and second ends and includes an expanded content panel at least partly defined by the first end of the label and extending past the second end of the label on the tube, and a release coating on a front side of the label positioned opposite to releasably adhere to the backside of the expanded content panel on the tube.

13. The method of claim 12, wherein content is printed on the expanded content panel.

14. The method of claim 12, wherein content is printed on the label.

15. The label of claim 12, wherein opening the expanded content panel reveals content on the label.

16. The method of claim 12, wherein the expanded content panel is permanently detachable from the label.

17. The method of claim 11, wherein the label further comprises a tamper evident feature including a panel that extends from, and is removably attached to, an edge of the label.
